(19) United States
(12) Patent Application Publication
(10) Pub. No.: US 2020/0253810 A1
(43) Pub. Date: Aug. 13, 2020

(54) MASSAGE BROOM

(71) Applicant: Sergej DUBROWSKI, Minsk (BY)

(72) Inventor: Sergej DUBROWSKI, Minsk (BY)

(21) Appl. No.: 16/782,925

(22) Filed: Feb. 5, 2020

(30) Foreign Application Priority Data
Feb. 8, 2019 (BY) RU 2019103736

(51) Int. Cl. A61H 7/00; A46D 1/00; A46B 3/00; A46B 9/06; A46B 15/00

(52) U.S. Cl. CPC A61H 7/003; A46D 1/0207; A46B 3/00; A46B 2200/102; A46B 15/0087; A46B 15/0028; A46B 9/06

(57) ABSTRACT

The group of useful models has to do with physiotherapeutic devices, in particular massage brooms, the task of which is to enhance their effectiveness. The massage broom has metal bristles, which have been put together compactly in a portion of the massage broom in order to form a handle, and in the remaining portion of the massage broom the bristles are separated from one another. In one of the variants, the handle or its part is formed by the metal sleeve and by the additional metal sleeve. The bristles are passed through these sleeves. Thus, the possibility exists that sound waves can be generated upon tapping. Various instances of embodiments of massage brooms in four variants are also described.

### CROSS-REFERENCE TO RELATED APPLICATION

This application is a national application and claims the benefit of the priority filing date of Russian Patent Application no. RU 2019103736 filed on Feb. 8, 2019 with the Russian Patent and Trademark Office. The earliest priority date claimed is Feb. 8, 2019.

### FEDERALLY SPONSORED RESEARCH

Not Applicable

### SEQUENCE LISTING OR PROGRAM

Not Applicable

### BACKGROUND

One group of useful models relates to physiotherapeutic devices, all of which have the same intended use, namely manually tapping on human bodies with the common creative intention and with the assurance that in the process, the same technical result is attained in a fundamentally similar way.

A known massage broom [1, Taoist massage broom (massage broom made of metal bristles), published on the internet at http://restartstudios.ru/daosskijvenik-stalnoj-venik/; access date: Nov. 19, 2018] has bristles that are joined to one another at one of their ends and that thereby form a handle. The handle has a fabric covering and is firmly joined at various points to a trimming. The bristles are separated from one another on their other ends.

The disadvantages of this kind of analogous the massage broom are its complicated construction and its bulk, both because of the presence of its trimming and because of the protruding wrapped part of the handle covering.

In addition, using this kind of massage broom has some inconveniences because of the many irregularities that arise in the trimming that is made up of strings/threads, the knots in the strings, and the protruding wrapped part of the handle covering. It is also possible that the trimming, which is made up of strings, will unravel during use.

A simpler and more compact construction that is also more practical and reliable is found in a general prototype of useful models of massage brooms [2, iron massage broom for toughening and massaging, published on the internet at https://www.livemaster.ru/item/15879159-dlya-doma-i-interera-zheleznyj-venik-dlya-zakalki-i-massazha; access date: Nov. 19, 2018], which has bristles that are bound compactly into a handle in part of the massage broom. The outer surface of the handle comprises a fabric covering, which is applied to the handle and is tightly around with a trimming made up of strings. In this broom, the bristles are separated from one another.

A disadvantage of the massage broom prototype [2] is the poor efficiency of its use, because of the fact that the vibrations of each of the bristles cannot fully be utilized for physiotherapeutic purposes. When the mix is used in such a way that with it a person taps on the human body, the vibrations in the handle in the overall mass of adjoining ends of the bristles are rapidly damped.

In order to generate more or less stable vibrations, the massage brooms, both in the analog [2] and in the prototype [1], are provided with a sufficiently high number of bristles, and have an increased length. Such massage brooms are therefore bulky and heavy.

Furthermore, because of the large number of bristles, these are primarily intended for tapping on human bodies, and are not suitable for other physiotherapeutic measures, such as injecting local areas with acupuncture points using the ends of the bristles or smoothing the selected body region using the handle end.

Accordingly there is a joint object for a group of useful models in enhancing the efficiency of using massage brooms in order to achieve their physiotherapeutic effect, based on the technical outcome, namely the enhancement of the duration of vibration of each individual bristle when massage brooms are used that have a smaller number of shortened bristles than in prototype [2] for improving the compact structure and reducing the weight of the massage broom.

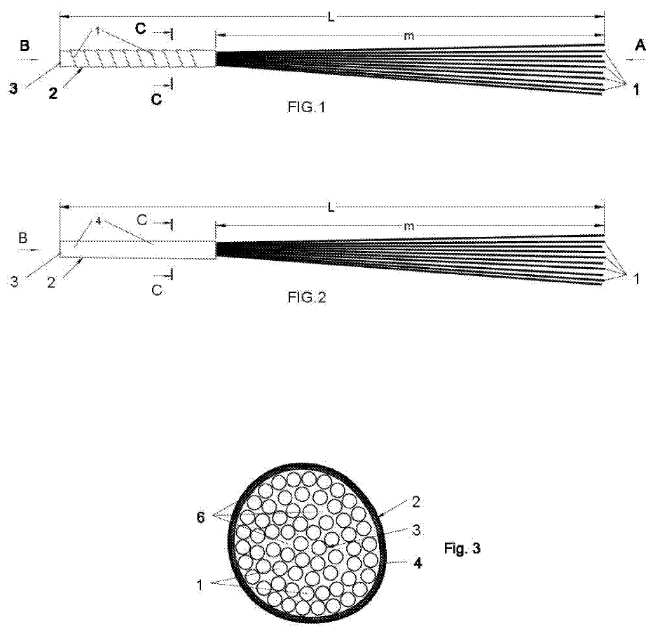

The object intended for the first useful model (FIGS. 1-3) is attained in that in massage brooms comprising metal bristles (1), which are bound together compactly in a portion of the massage broom to form a handle (2), the outer surface of this handle (2) is formed by compression through a metal tube or by wrapping the aforementioned portion with decorative material (4). Here the bristles (1) on the other part of the massage broom are separated from one another. There are distinguishing features here: The portions of some or all of the bristles (1) in the handle (2) are either isolated from one another by elastic elements (5, 6) or are tightly bound together.

Because these bristles are isolated completely or partially, it is possible, when someone is tapping on a human body with massage brooms, for the bristles to vibrate, without the vibrations in the handle of the massage broom being substantially damped by the total mass of the parts of the bristles. As a result, long-lasting vibrating waves occur, which have a strong physiotherapeutic effect on the human body.

Furthermore, in contrast to the prototype [2], it is not necessary to use a great number of elongated bristles; this makes the massage broom lighter in weight and more compact.

An additional distinguishing feature of the first useful model for enhancing the aforementioned effects is that the bristles (1) are made of stainless steel.

The intended object for the second useful model (FIG. 11) is attained in that the massage broom, which comprises metal bristles (1), is put together compactly in a massage broom portion with the handle (2) formed, and the remaining bristles (1) of the massage broom, on the other part of the massage broom, are separated from one another. The distinguishing features are that the handle (2), or part of it, is formed by a metal sleeve (9), through which the bristles (1) are passed, so that when tapping is done, sound waves can occur.

These distinguishing features make it possible upon tapping with the bristles on a person's body, each of the bristles vibrates, without the waves in the handle of the massage broom being substantially damped onto the total mass of the parts of the bristles, since as happens with a bell, the resonance waves from the metal sleeve return to the vibrating bristles. Their vibrations thus increase, and the result is a sonic vibration. Thus, long-lasting vibration waves are generated, which lead to a strong physiotherapeutic effect on the human body.

As a result, a smaller number of short bristles can be inserted in the massage broom compared to the prototype [2], so its weight is reduced and the ease of use is enhanced.

Additional distinguishing features of the second useful model for enhancing the effects mentioned are these:
The bristles (1) are passed through the metal sleeve (9), and the bristles are compressed in the handle.
The outer surface of the handle (2) is wound around with decorative material (4); this is done in such a way that this material is wound in overlapping fashion along the handle (2) about an insulation fabric tape (6) with adhesive on one side or both sides, and the adhesive is likewise wrapped in overlapping fashion firmly onto the metal sleeve (9) or some of the bristles (1), thereby forming the handle.
The handle (2) is likewise formed by a cap (13), in which the bristles are passes under tension, and the end of the cap is rounded.
An additional metal sleeve (12), at a distance from the metal sleeve (9), was used; because of it, the bristles (1) are also passed through, and are compressed thereby.
The metal sleeve (9) is embodied in elongated fashion, so that it forms only the handle (2), specifically either without compression or with compression of the bristles (1).

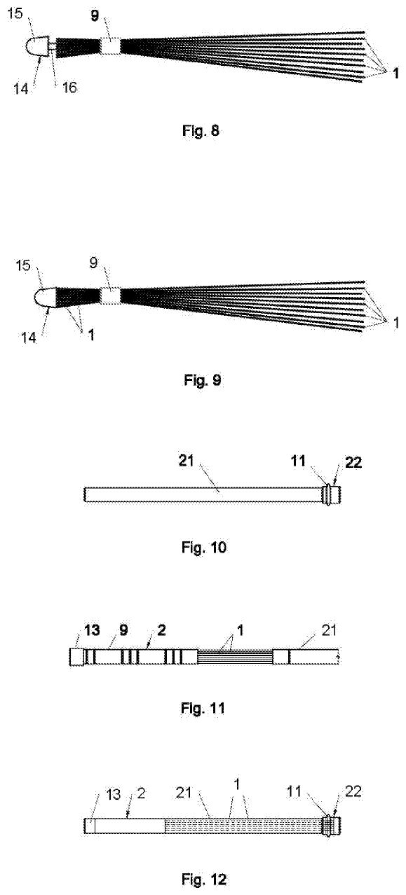

The object stated for the third useful model (FIGS. 8 to 10) is attained in that the bristles (1) of the massage broom in the section of the massage broom having a molding are put together compactly. Their outer surface is formed by wrapping the aforementioned portion with decorative material (4), while the other bristles (1) of the massage broom are separate from one another. The distinguishing features are then that the tip (16) of the knob (14) is also located in the handle (2), and the base body (15) of the knob is located behind the end of the handle (2).

This kind of implementation of the knob in the massage broom acts as a damper so that the vibrations that are generated by the bristles quickly fade into the space behind the handle of the massage broom. Thus, when the massage broom is used for tapping, the vibrations of the bristles last longer, and continuous vibration waves are created; because of them, a strong physiotherapeutic effect on the body is achieved.

Furthermore, if the user's hands are especially sweaty and the user is holding the massage broom while it is being used, the knob prevents the user's hands from slipping off. This enhances the ease of use and the general efficiency.

The knob can also be used as a massage element, thus expanding the functionality of the massage broom and increasing the efficiency of its employment.

This makes it possible to make do with massage brooms that have a lesser number of bristles than in prototype [2] and that are furthermore shorter. As a result, the weight is reduced and the ease of use is enhanced.

An additional distinguishing feature of the third useful model, which is aimed at improving the aforementioned effect, is that the base body (15) of the knob (14) is rounded.

The object (FIG. 12) intended for the fourth useful model is attained in that the bristles (1) in the massage broom, in the portion of the massage broom embodying the handle (2), are put together compactly, and that the bristles (1) in the remaining portion of the mes are separated from one another. There are accordingly the following distinguishing features: The handle (2) is formed by a metal sleeve (9), on one end of which the ends of the bristles (1) are passed through the metal sleeve (9) and compressed; the hollow space (19) in the metal sleeve acts as a resonator for the sound waves that occur when the user is tapping with the bristles.

The aim of such distinguishing features of the fourth useful model is to generate a sufficiently loud, melodic, and long-lasting sonority of the massage broom as well as to generate continuous vibration waves. Together, this ensures a strong physiotherapeutic effect.

Additional distinguishing features of the fourth useful model, which are directed to enhancing the aforementioned effect, are these:
A cap (13) is placed on or onto the other end of the metal sleeve (9), or a knob (14) is built in there, while the face end front end of the cap (13) or of the knob (14) is rounded.
The hollow space in the metal sleeve (9) is filled with solid elements (20), and as a result it is possible generate a sound when the solid elements collide with the surface of the metal sleeve.

The following are general additional features for all the useful models
The massage broom is embodied such that it can be placed in the tube (21). One of the ends is provided with a blind plug (22) and is embodied such that it can be used for massage.

### The invention will be described in conjunction with the appended drawings. In the drawings:

FIGS. 1, 2 each show one variant of general types of embodiments of the massage broom,

FIG. 3 shows the view B of FIGS. 1 and 2;

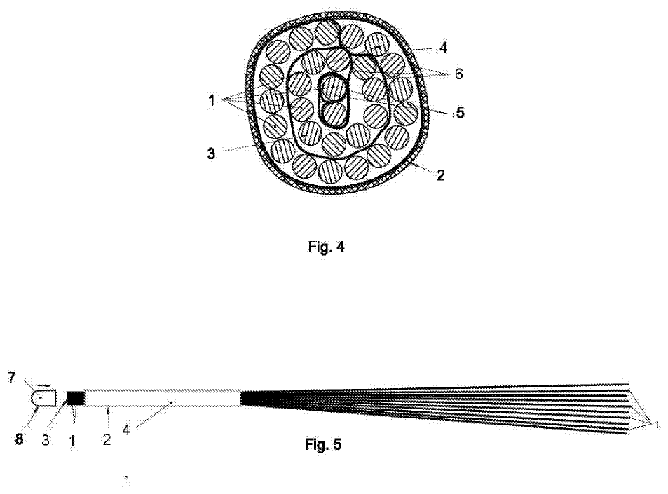

FIG. 4 shows a section C-C of FIG. 1 when two portions of the bristles in the handle of the massage broom are isolated;

FIG. 5 shows a massage broom with one free end of its handle complete with a cap;

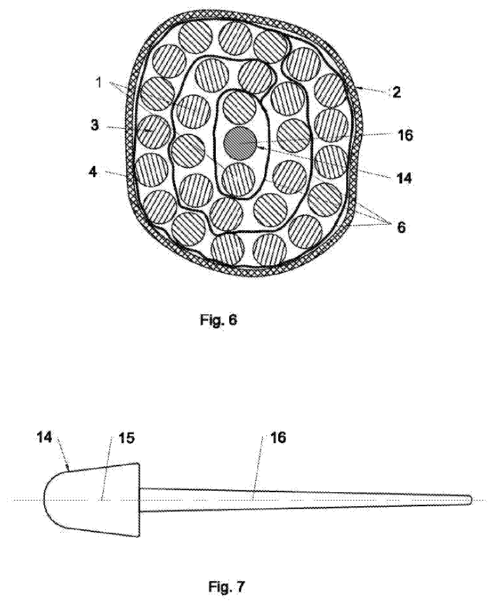

FIG. 6 shows a section F-F;

FIG. 7 shows the general types of a knob, which is variously made of wood, metal and plastic;

FIG. 8 shows the prefabricated massage broom, in which the bristles crimped by the sleeve closer to the middle part of the bristles, and the knob is prepared from its end outward for insertion into the bristle bundle;

FIG. 9 is the same as in FIG. 8, except that the knob is inserted into the handle;

FIG. 10 shows the full view of the additional element of the massage broom, namely a tube/blind plug;

FIG. 11 shows the process of inserting the massage broom into the tube; and

FIG. 12 shows the massage broom inserted into the tube.

The massage broom in various embodiments has bristles 1, which in the portion of the massage broom forming the handle 2 are put together compactly, with both one free end 3 (FIGS. 3, 5) and one damped end.

The length m is the part of the massage broom (FIGS. 1, 2) in which the bristles are separated from one another by more than ⅔ of the total length L from the massage broom. The recommended thickness of the bristles 1 can be selected in the range from 2 to 4 mm, and there are preferably 27 of them in the massage broom. By experimentation, it has been ascertained that such parameters not only ensure relatively light weight and compactness of the massage broom but also its improved action when used.

The bristles 1 can be made of various materials; preferably stainless steel is preferred.

In one embodiment of the massage broom, the outer surface of its handle 2, in the part in which the bristles are put together compactly on the massage broom portion, by wrapping a decorative material, such as the trimming 4 (FIGS. 1, 2, 3, . . . ), which is wrapped in overlapping fashion along the handle 2. In the remaining portion of the massage broom, the bristles 1 are separated from one another.

The portions of some bristles 1 (FIGS. 3, 5) in the handle 2 are partially or entirely insulated from one another by elastic elements.

One such complete or partial insulation/isolation of the bristles makes it possible for them to vibrate when the massage broom taps on a person's body, without substantially damping the vibrations in the handle of massage brooms with regard to the total mass of the parts of the bristles located there. As a result, long-lasting vibration waves are generated, and as a result a strong physiotherapeutic effect on the human body is achieved.

At the same time, in contrast to the prototype [2], in many massage brooms no elongated bristles are used, and as a result these brooms are lighter in weight and more compact.

As an elastic element, either a rubber layer 5 (FIG. 4) or an insulation/isolation fabric tape 6 with a two-sided adhesive (not shown) can be used. The portions of the bristles have first been partially wrapped spirally on the handle 2 (FIGS. 3, 5). Then, a continuous layer of the insulation/isolation fabric tape 6 is wrapped in superficially overlapping fashion along the handle 2, and the trimming 4 is wound around the upper adhesive layer of the insulation/isolation fabric tape 6 (FIGS. 1, 2, 4).

The massage broom can be equipped with a cap 7 (FIG. 5), in which the front part/face end 8 is rounded. It is passed with tension into the short ends of the bristles 1 and thus forms an element for the purpose of massaging (applying pressure, rubbing, smoothing).

In another instance of the embodiment of the massage broom, the handle 2, or a part of it, can be made by means of a metal sleeve 9 (FIG. 9), for instance of stainless steel. The bristles 1 are passed into the sleeve and compressed.

If a relatively short metal sleeve 9 is used, decorative material in the form of a trimming 4 is also used on the handle 2; this material is wrapped along the handle 2 with insulation/isolation fabric tape 6 with two-sided adhesive, which is likewise wrapped tightly behind it on the metal sleeve 9 and some of the bristles 1.

The leather tape 10, which is wrapped on the main part of the handle over the upper adhesive layer of the insulation/isolation fabric tape 6, can also be used as decorative material. Simultaneously, the metal sleeve 9 is wrapped tightly with the trimming 4.

The metal sleeve 9 can be compressed onto the bristles 1 as an additional massage element, forming annular, rounded projections 11.

A further metal sleeve 12, which is located spaced apart from the metal sleeve 9, can also be used. The bristles 1 are compressed by a compression tool.

The metal sleeve 9 and the additional metal sleeve 12 can be compressed, forming a cross-sectional or polygonal contour. In these cases, unlike the example of the massage broom without wrapping, the handle 2 can be formed, specifically as in FIGS. 1, 2, with insulation/isolation fabric tape 6 and in overlapping fashion with trimming 4, or it can be wrapped with the trimming (not shown), or as in the case of the massage broom of FIG. 8 it can be wrapped with this trimming and with leather tape 10, or without first being wrapped with a trimming 4.

The metal sleeve 9 can be embodied in elongated fashion, so as to form only the handle 2 of the massage broom, both with and without compression of the bristles 1.

The handle (2) can also be formed by a cap 13, into which bristles 1 are passed under tension, and the end of which is rounded and forms a massage element. The cap 13 can also conceal the metal sleeve 9.

In still another case of the embodiment of the massage broom, a knob 14 (FIG. 7) placed in the handle 2 or a part of the handle can be used as an element for performing a massage. The base body 15 of this knob is of stainless steel or magnetic material or wood (FIG. 7) or plastic and is located behind the end of the handle 2.

The tip 16 of the knob 14 can be embodied with its base body 15 as a one-piece part (FIG. 7) and can also be screwed together by means of a thread 17 and passed into the handle 2.

The base body 15 of the knob 14 serves to perform a massage with a rounded end.

In the latter case of the embodiment of the massage broom, the massage broom has the bristles 1, which are put together compactly in the massage broom portion, forming the handle 2. In the remaining portion of the massage broom, the bristles 1 are separate from one another. At the same time, the handle 2 is formed by a metal sleeve 9, the ends of which are passed through one end of the bristles 1. Their compression is effected by the metal sleeve 9, the hollow space 19 of which has the capability of acting as a resonator of sound waves that occur when the tapping with bristles.

A cap 13 can be placed on the second end of the metal sleeve 9, or a knob 14 of various materials can be inserted into this end. For the purpose of massaging or rubbing, the ends of the cap 13 and of the knob 14 are rounded.

In this case, the hollow space in the metal sleeve 9 can be filled with solid elements 20, for instance balls of different diameter (as shown) that are of metal, glass or ceramic as well as stones, sand, or in various combinations of the aforesaid materials. The possibility then exists of also generating tones when these elements collide with the surface of the metal sleeve 9.

The metal sleeve 9 can be wrapped with the trimming 4, in either the same pattern or different patterns.

In all the above-described variants, the massage brooms can be embodied in such a way that they are located in the tube 21. One end of this tube is provided with a blind plug 22. This plug has the capability of performing the massaging or rubbing, for instance by means of the embodiment of an annularly rounded projection 11 and rounding of the end.

The massage broom, or two massage brooms, are employed for physiotherapeutic purposes for persons 23 or by the trainer 24 or (not shown) by the person who performs this action 23 himself, by tapping with bristles 1 or by poking with the free ends of the bristles, or tapping, pressing or rubbing, or smoothing the selected body region with the knobs 14 of the massage brooms.

For example, on the body of the person 23 lying on the bench 25, the trainer 24 performs a cyclical tapping with bristles 1 of the massage broom in varying rhythms. After that, the trainer pokes at the feet or palms of the hand with the ends of the bristles 1 of the massage broom.

After that, rubbing, pressing, tapping and smoothing are done by means of knobs 14 of the massage broom, for instance being applied to the feet of the person 23 who is receiving the treatment.

The massage brooms can be employed in combination with stretching the upper part of the spine of a person 23 who is receiving the Glisson treatment, for instance by tapping or rubbing, pressing, tapping, smoothing with knobs 14 of the massage brooms.

In tapping with a massage broom or a plurality of massage brooms on the body of the person 23, who is receiving the treatment, a synergy of impacts occurs, and vibrations of the bristles 1 arise from their collision with one another. A vibration of this kind is lasts for a long time without the vibrations in the handle of the massage broom becoming quickly damped there for the total mass of the parts of the bristles 1.

As a result, a significant physiotherapeutic effect is attained, which is intensified by the use of massage broom knobs 14, free ends, and by the use of massage brooms with metal sleeves 9 (FIG. 9), because sound waves are generated. This is also done using massage brooms together with other physiotherapeutic devices. Furthermore, rubbing the body can be done with the aid of annularly rounded projections 11 of the metal sleeve 9 of the massage broom or annularly rounded projections 11 of the tube 21, which also acts as a kind of scissors, toward which the massage broom with its bristles 1 is inserted and retracted.

The use of the massage broom in accordance with the useful model aims at the cleansing effect on the human body, for the following reasons:
overcoming the effects of stagnation, improving the lymphatic circulation, elimination of toxins, salts, fluids;
the effect of “warming the body”, the improvement in the supply of oxygen and nutrients to the organs, normalization of the peripheral circulation;
strengthening the bones and joints;
burning fat, anti-cellulite effect, normalizing the weight of a person;
rejuvenation of the bone marrow and thus of the entire human body.

### SOURCES OF INFORMATION

1. Taoist massage brooms (massage brooms with iron bristles); internet source: http://restartstudios.ru/daosskij-venik-stalnoj-venik/; access date: Nov. 19, 2008
2. Massage brooms with iron bristles for toughening and massaging; internet source: https://www.livemaster.ru/item/15879159-dlya-doma-i-interera-zheleznyj-venik-dlya-zakalki-i-massazha; access date: Nov. 19, 2018/prototype/.

### LIST OF REFERENCE NUMERALS

1 Bristle
2 Handle
3 End of handle 2
4 Trimming
5 Rubber layer
6 Insulation fabric tape
7 Cap
8 Face end of the Cap 7
9 Metal sleeve
10 Leather tape
11 Annularly rounded projection
12 Additional metal sleeve
13 Cap
14 Knob
15 Base body of the knob 14
16 Tip of the knob 14
17 Threaded sleeve
18 Striker
19 Hollow space in the metal sleeve
20 Solid element
21 Tube
22 Blind plug of the tube for 20
23 Person being treated
24 Trainer
25 Bench
26 Glisson's Loop

1. A massage broom having metal bristles, which are put together in compact form in a portion of the massage broom, forming the handle, the outer surface of which massage broom is formed by compressing a metal tube or by wrapping the aforementioned portion with decorative material, and in which in the remaining portion of the massage broom the bristles are separated from each other,
wherein
the portion of some or all of the bristles in the handle are insulated from one another by means of elastic elements.

2. The massage broom of claim 1,
characterized in that
the bristles are made of stainless steel.

3. A massage broom having bristles, which are put together compactly in the portion of the massage broom, forming a handle, and in which the bristles in the remaining portion of the massage broom are separated from one another,
wherein
the handle or a portion of the handle is formed by a metal sleeve, through which the bristles are passed, and the possibility exists that when being tapped, sound waves are generated.

4. The massage broom of claim 3,
wherein
the bristles are passed through a metal sleeve and compressed by a compression tool.

5. The massage broom of claim 3,
wherein
the outer surface of the handle is wound about with decorative material, which is wound along the handle by a one-or two-sided adhesive tape, which is likewise tightly wound around the metal sleeve or on the some of the bristles behind it, which part forms the handle.

6. The massage broom of claim 3,
wherein
the handle is likewise formed by a cap, into which the bristles are passed under tension, and the end of which cap is rounded.

7. The massage broom of claim 3,
wherein
the metal sleeve, placed at a distance from the metal sleeve through which the bristles are passed, is the one that is compressed.

8. The massage broom of claim 3,
wherein
the metal sleeve is embodied in elongated fashion, in order thereby to form only the handle, and either no compression of the bristles takes place.

9. A massage broom comprising bristles, which are put together in compact form in a portion of the massage broom, forming the handle, the outer surface of which massage broom is formed by wrapping the aforementioned portion with decorative material, and the bristles in the remaining portion of the massage broom are separated from one another,
wherein
the handle of the knob is also located in the handle, the base body of which is located behind the end of the handle.

10. The massage broom of claim 3,
wherein
the base body of the knob is rounded.

11. A massage broom having bristles, which are put together compactly in the portion of the massage broom, forming a handle, and in which the bristles in the remaining portion of the massage broom are separated from one another,
wherein
the handle is formed by a metal sleeve, in one end of which the ends of the bristles are passed through the metal sleeve by the compression of the bristles, the hollow space of which sleeve is capable of acting as a resonator of sound waves that are generated when tapping with the bristles.

12. The massage broom of claim 11,
wherein
on the end or into another end of the metal sleeve, the cap is placed or the knob is built in, and the face end of the cap or knob is rounded.

13. The massage broom of claim 11,
wherein
the hollow space in the metal sleeve is filled with solid elements, as a result of which it is possible to generate sound when the solid elements collide with the surface of the metal sleeve.

14. The massage broom of claims 1,
wherein
it is embodied with the possibility of its placement in the tube, one end of which is provided with a blind plug, so that the massage can be performed.
